(19) United States
(12) Patent Application Publication
(10) Pub. No.: US 2002/0140710 A1
(43) Pub. Date: Oct. 3, 2002

(54) Method and apparatus for dynamically balancing graphics workloads on a demand-based zone renderer

(76) Inventor: Brandon L. Fliflet, Elk Grove, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/824,887

(22) Filed: Apr. 2, 2001

(51) Int. Cl. G09G 5/00

(52) U.S. Cl. 345/660

(57) ABSTRACT

A method for balancing workloads of graphics related software and hardware associated with a zone renderer rendering at least one object comprising configuring the zone renderer to a predetermined size, monitoring hardware or software for a predetermined time period, determining whether there is an imbalance between the hardware and software, and adjusting the size of the zone renderer to minimize the imbalance.

### BACKGROUND

1. Field

The present invention relates generally to graphics systems and more particularly to graphics rendering systems.

2. Background Information

Computer graphics systems are commonly used for displaying graphical representations of objects on a two-dimensional video display screen. Current computer graphics systems provide highly detailed representations and are used in a variety of applications. In typical computer graphics systems, an object to be represented on the display screen is broken down into graphics primitives. Primitives are basic components of a graphics display and may include points, lines, vectors and polygons, such as triangles and quadrilaterals. Typically, a hardware/software scheme is implemented to render or draw the graphics primitives that represent a view of one or more objects being represented on the display screen.

The primitives of the three-dimensional objects to be rendered are defined by a host computer in terms of primitive data. For example, when the primitive is a triangle, the host computer may define the primitive in terms of X, Y and Z coordinates of its vertices, as well as the red, green and blue (R, G and B) color values of each vertex. Additional primitive data may be used in specific applications.

Graphics rendering is the process of computing two-dimensional image (or part of an image) from three-dimensional geometric forms. A renderer is a tool which performs graphics rendering operations in response to calls thereto. Although some renderers are exclusively software and some are exclusively hardware, graphics rendering systems are typically implemented using a combination of both (e.g. software with hardware assist or acceleration). Renderers typically render scenes into a buffer which is subsequently output to the graphical output device, but it is possible for some renderers to write their two-dimensional output directly to the output device. A graphics rendering system (or subsystem), as used herein, refers to all of the levels of processing between an application program and a graphical output device.

Rendering hardware interpolates the primitive data to compute the display screen pixels that represent the each primitive, and the R, G and B color values of each pixel. Conventional graphics rendering systems suffer from problems which limit their usefulness in one way or another. For example, rendering systems may suffer from a disparity in performance between the software driver and graphics hardware. In particular, a large amount of work is required for performing rendering calculations and command broadcasting. One possible way to address this problem is revert to an alternative rendering algorithm if performance is unsatisfactory. However, this is an avoidance of the problem, rather than a solution.

What is needed therefore is a method and apparatus for balancing software and hardware workloads on a graphics renderer.

### BRIEF DESCRIPTION OF THE DRAWINGS

FIG. 1 is a simplified block diagram of a computer system implementing an embodiment of the present invention.

FIG. 2 is a depiction of a zone renderer illustrating geometric primitives that are broken up into screen-spaced zones according to an embodiment of the present invention.

FIG. 3 is a flow diagram of a process for optimizing system performance by dynamically balancing graphics software and hardware workloads on a zone renderer in accordance with an embodiment of the present invention.

### DETAILED DESCRIPTION

An embodiment of the present invention is a method for optimizing system performance by dynamically balancing graphics software and hardware workloads on a demand-based zone renderer in accordance with the present invention. Embodiments of the present invention determine whether there is an imbalance between the software driver and graphics hardware and automatically adjust the software zone size accordingly. The effect of adjusting the software zone size is increased or decreased cache efficiency and increased or decreased processor workload in an attempt to increase overall system performance. If the graphics hardware is the bottleneck, embodiments of the present invention cause the software driver to do more work thus optimizing the graphics hardware's cache. If the software driver is the bottleneck, embodiments of the present invention cause the software driver to do less work thus optimizing the graphics hardware's cache. Embodiments of the present invention thus exploit the render cache as much as possible while not causing too much work for the software driver.

In the detailed description, numerous specific details are set forth in order to provide a thorough understanding of the present invention. However, it will be understood by those skilled in the art that the present invention maybe practiced without these specific details. In other instances, well-known methods, procedures, components and circuits have been described in detail so as not to obscure the present invention.

Some portions of the detailed description which follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

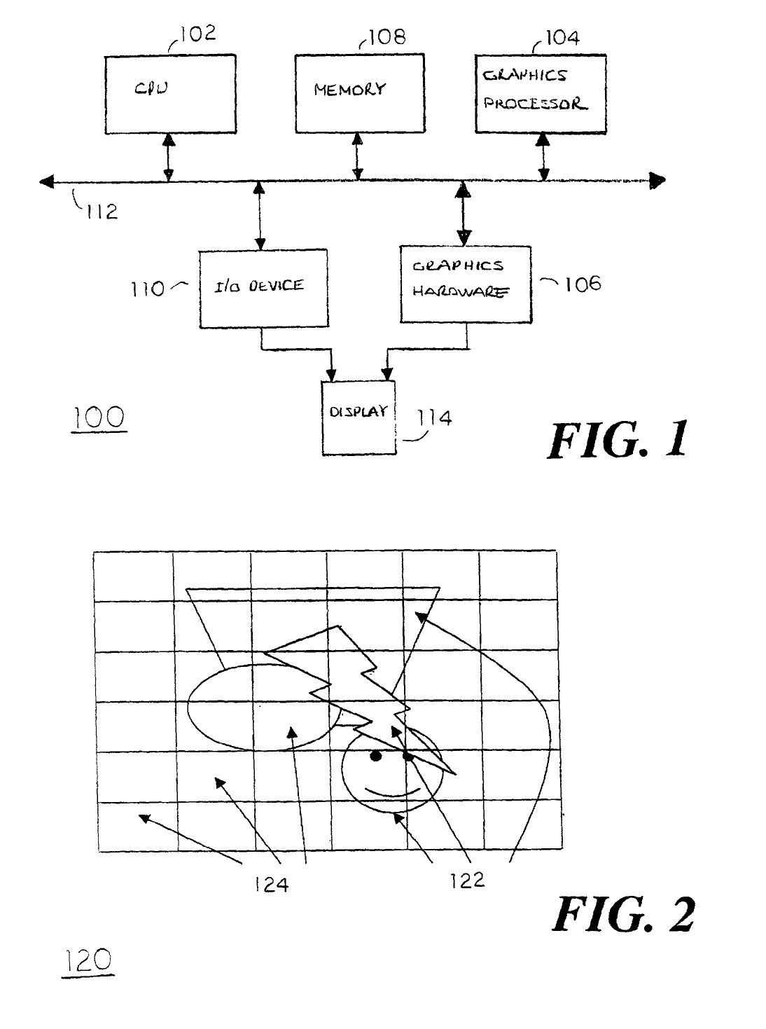

An example of one such type of processing system is shown in FIG. 1. Sample system 100 may be used, for example, to execute the processing for methods in accordance with the present invention, such as the embodiment described herein. Sample system 100 is representative of processing systems based on the microprocessors available from Intel Corporation, although other systems (including personal computers (PCs) having other microprocessors, engineering workstations, set-top boxes and the like) may also be used. In one embodiment, sample system 100 may be executing a version of the WINDOWS.TM. operating system available from Microsoft Corporation, although other operating systems and graphical user interfaces, for example, may also be used.

FIG. 1 is a block diagram of a system 100 of one embodiment of the present invention. The computer system 100 includes central processor 102, graphics processor 104, graphics rendering hardware 106, memory 108, I/O device 110, common bus 112 and display device 114 all connected to common bus 112. Processor 102 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Processor 102 may be coupled to common bus 112 that transmits data signals between processor 102 and other components in the system 100.

Processor 102 issues signals over common bus 112 for reading and writing to memory 108 or to I/O device 110 in order to manipulate data as described herein. Processor issues such signals in response to software instructions that it obtains from memory 108. Memory 108 may be a dynamic random access memory (DRAM) device, a static random access memory (SRAM) device, or other memory device. Memory 108 may store instructions and/or data represented by data signals that may be executed by processors 102 or 104. The instructions and/or data may comprise code for performing any and/or all of the techniques of the present invention. Memory 108 may also contain software and/or data (not shown). A cache memory may reside inside processors 102 and/or 104 that stores data signals stored in memory 108. Cache memory in this embodiment speeds up memory accesses by the processor by taking advantage of its locality of access. Alternatively, in another embodiment, the cache memory may reside external to the processors 102 and/or 104.

I/O device 110 may also be capable of issuing signals over bus 112 in order to access memory 108 in a particular embodiment. In some embodiments, graphics processor 104 can offload from CPU 102 many of the memory-intensive tasks required for rendering an image. Graphics processor 104 processes data signals and may be a complex instruction set computer (CISC) microprocessor, a reduced instruction set computing (RISC) microprocessor, a very long instruction word (VLIW) microprocessor, a process implementing a combination of instruction sets, or other processor device, such as a digital signal processor, for example. Graphics processor 104 may be coupled to common bus 112 that transmits data signals between graphics processor 104 and other components in the system 100, including graphics device 106 and display device 114. In these systems, the display buffer is typically held inside graphics device (including /binning and rendering hardware) 106 which can not only write specific attributes (e.g. colors) to specific pixels of display 114 as requested by processor 102 and/or 104, but can also draw more complicated primitives on the display device 114. Graphics device 106 interfaces to display device for displaying images rendered or otherwise processed by a graphics controller for displaying images rendered or otherwise processed to a user. Display device 114 may comprise a computer monitor, television set, flat panel display or other suitable display device.

As illustrated in FIG. 1, programs and data stored in memory 108 are processed by the processor. Memory 108 stores a host operating system that includes one or more rendering programs to build the images of graphics primitives for display. In particular, the method for optimizing system performance by dynamically balancing graphics software and hardware workloads on a demand-based zone renderer is stored in memory 108. The graphics primitives produced are laid out or rendered in the buffer memory for display on display device 114. System 100 includes graphics device 106, such as a graphics accelerator that uses customized hardware logic device or a co-processor 104 to improve the performance of rendering at least some portion of the graphics primitives otherwise handled by host rendering programs. The graphics accelerator is controlled by the host operating system program and its host graphics application program interface (API) through a driver program. The graphics primitives produced thereby are laid out or rendered in the buffer memory for display on display device 114.

Referring to FIG. 2, graphics device 106 includes a hardware zone renderer 120 that has a render cache that can be exploited to improve rendering performance. Zone rendering relies on graphics objects, such as primitives 122, being sorted into a grid of screen-space rectangles, commonly referred to as bins or zones 124. By requiring the driver to decompose geometric primitives (e.g., triangles, lines) 122 into zones 124 that are aligned to the cache, the rendering performance improves. Each primitive 122 is drawn in multiple passes, once for each zone 124 it covers. However, for each pass, only those pixels covered by the primitive 122 and contained in the zone 124 are drawn. The zone renderer 120 processes each zone 124 in turn, drawing all the primitives 122 that intersect the zone 124. The primary rationale for using a zone renderer 120 is to improve rendering performance through caching. Since the graphics hardware 106 is only working on a small portion of the screen at a time, it is able to hold the frame buffer contents for the entire zone 124 in an internal cache. Using this cache significantly reduces the memory traffic and improves performance relative to a traditional renderer that draws each primitive 122 completely before continuing to the next one.

Zones 124 are typically rectangularly shaped although one skilled in the art will recognize that the present invention can be implemented in conjunction with other geometrically shaped variants. A single primitive 122 may intersect many bins, thus requiring multiple replications. Once all the primitives 122 are sorted and the command structures completed, a second pass is made to render the scene one bit at a time making use of internal caches. Each primitive 122 is drawn in multiple passes, once for each zone 124 it covers. However, for each pass, only those pixels covered by the primitive 122 and contained in the zone 124 are drawn. The zone renderer processes each zone 124 in turn, drawing all the primitives 122 that intersect the zone 124. The zone renderer improves rendering performance through caching. In particular, since graphics device 106 is only working on a small portion of the screen at a time, it is able to hold the frame buffer contents for the entire zone in an internal cache. Using the internal cache significantly reduces the memory traffic and improves performance relative to renderers that draw each primitive 122 completely before continuing to the next one.

The process of assigning primitives (and their attributes) 122 to zones 124 in zone rendering is commonly referred to as binning. Binning performs the necessary computations to determine what primitives 122 lie in what zones 124 and can be performed by dedicated hardware or software implementations. In software implementations, primitives 122 are intersected with zones 124. The binning software driver writes out a set of commands to be parsed by the rendering hardware 106 for each zone 124 and the commands are written into zone buffers.

In order to implement a tile-rendering architecture like zone rendering, the maintenance of the correct graphics rendering state variables within each zone 124 is important. The binning software driver handles different types of commands, including but not limited to:

Fast State Variables: Includes frequently changed attributes of geometry, including but not limited to texture map information and blending modes. There are at least several different groupings of fast state and the rendering hardware 106 keeps a complete copy of each.

Slow State Variables: Includes infrequently changed attributes of geometry, including but not limited to stipple patterns. The binning driver writes these commands into separate slow state zone buffers, and provides to the rendering hardware 106 the relevant pointers (start and end pointers) into these buffers.

Primitives: Generally, the actual geometry, including but not limited to lines and triangles, to be drawn. The binning driver provides indices to the rendering hardware 106 for accessing the associated vertex data, for example, X, Y coordinates and color.

The binning driver assigns primitives 122 to zones 124 as follows:

1. Fast State: Determine if the fast state group has been written into a corresponding zone buffer. If not, the binning driver proceeds to write a copy of the fast state group into the bin buffer.

2. Slow State: Determine if the slow state group has been written into a corresponding zone buffer. If not, the binning driver writes a slow state pointer update command into the zone buffer.

3. Primitives: The binning driver writes primitive commands into the zone buffer.

From the perspective of the rendering hardware 106, the process of assigning fast or slow state commands to zone buffers is demand-based. Commands are seen in a zone buffer only if a primitive 122 using that state intersects the corresponding zone 124. The complete set of state commands sent by the binning driver is likely not seen in the zone buffer.

The zone rendering hardware thus accepts streams of graphics primitives 120 and state commands, commonly referred to as a scene input list. The zone renderer will parse this list, determine which bins each primitive intersects, and replicate the primitive (and possibly preceding state commands) into command structures associated with each bin (known as bin lists). Each bin list is comprised of a chained series of command buffers stored within non-contiguous physical memory pages. A bin pointer list, maintained in graphics memory, is used to store the initial and subsequent current pointer into the bin list for each bin.

The performance of the binning driver is directly affected by the number of zones 124 per screen and the related zone size. As the zone size increases, the number of zones 124 per screen decreases as does the amount of work the binning driver performs. Alternatively, as the zone size decreases, the number of zones 124 per screen increases as does the amount of work the binning driver performs.

The rendering hardware 106 and binning driver primarily influence graphics performance. The present invention balances the rendering hardware 106 and binning driver in such a way as to improve the overall performance. If the rendering hardware 106 is the bottleneck, the present invention causes the binning driver to do more work thus optimizing the rendering hardware's cache. If the binning driver is the bottleneck, the present invention causes the binning driver to do less work thus optimizing the rendering hardware's cache. The present invention thus exploits the render cache as much as possible while not causing too much work for the binning driver.

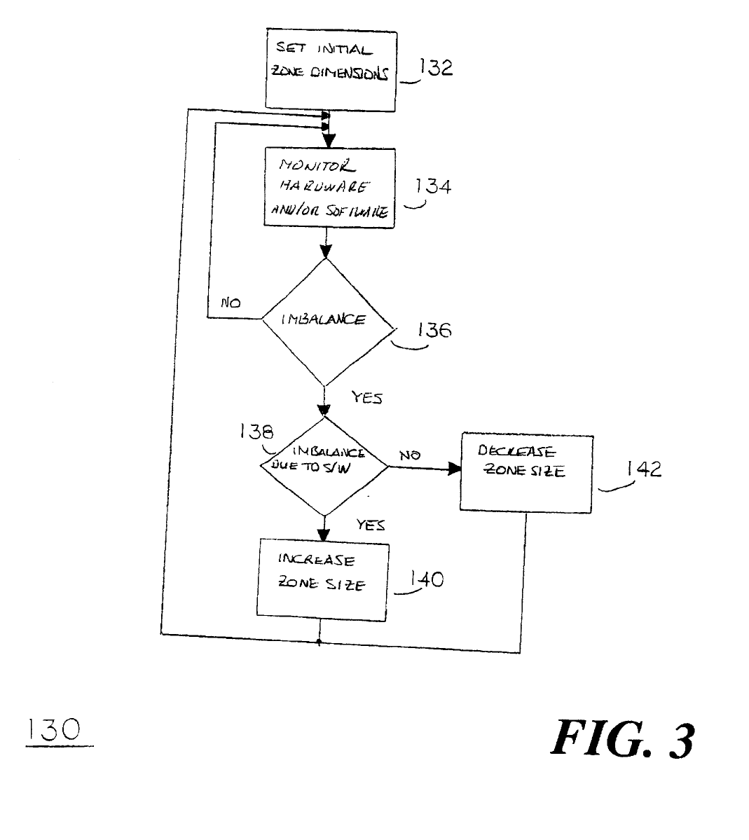

FIG. 3 is a flow diagram 130 illustrating a process for balancing software and hardware workloads on a demand-based zone renderer by dynamically adjusting the software zone size such that it is compatible with the graphics hardware zone dimensions according to an embodiment of the invention. A zone size is compatible if it is generally equivalent to the graphics hardware zone dimensions. However, the optimal software zone size for one application may not be optimal for another. For example, there are applications where being equivalent is not necessary. Embodiments of the present invention determine whether there is an imbalance between the software driver and graphics hardware and automatically adjust the software zone size accordingly. The effect of adjusting the software zone size is increased or decreased cache efficiency and increased or decreased processor workload in an attempt to increase overall system performance.

Initially, at block 132, the zone dimensions 120 are initially set to a predetermined size depending on the application. In some embodiments, the predetermined size is equal or approximately equal to the hardware cache size although one skilled in the art will recognize that the zone size can be set to other suitable sizes as well. A possible cache dimension (in pixels) supported by this implementation for a 32 BPP mode is 64 pixels wide by 32 pixels high. Correspondingly, for zone rendering, the minimum zone size would be approximately equal to the hardware cache size of 64 pixels wide by 32 pixels high.

A predetermined number of graphics frames are then run to gather performance data (block 134). The number of frames required varies based on numerous factors, including but not limited to the desired level of performance, particular criteria used, type of hardware and/or software monitoring utilized and so forth. In a typical implementation, adequate performance data is gathered over every three frames.

At block 134, the graphics hardware and/or software driver are monitored to determine whether there is an imbalance. One or more factors can be monitored to determine whether the software zone size should be changed to compensate for an imbalance in workload between the driver and the hardware. The factors can include, but are not limited to, driver counters or other performance heuristics. For example, the graphics hardware 106 is polled periodically (for example, every couple of cycles) to determine how frequently and how long it is sitting idle. If the frequency is above a predetermined threshold, the zone size is changed dynamically to balance the hardware and software workloads.

It is possible to determine whether the binning driver is consuming an unusually large amount of CPU workload by measuring the total driver time for a given scene compared to the overall time (including application and other system components) and calculate a driver CPU utilization ratio. If this ratio rises above a given threshold, and the hardware 106 is sitting idle as noted above, the software zone size is accordingly adjusted.

If there is an imbalance, the software zone size to adjusted to address the imbalance and/or bottleneck (block 136). In particular, when there is a bottleneck due to the binning driver (block 138), the software zone size (i.e. rectangular bin) is accordingly increased such that the software driver's view of the hardware cache is larger than what it really is (block 140). This reduces the driver workload and correspondingly increases the graphics hardware workload. The increase in the graphics hardware workload is attributed to decreased efficiency of the cache. Thus, if the binning driver is causing the bottleneck, the zone size is increased. For example, the present invention is particularly applicable to applications that are bottlenecked by the CPU (i.e. very large geometric complexity) while the hardware has the ability to do more work. The result, based on the present invention, would be to increase the zone size, thus reducing the CPU workload in the driver at the cost of having the graphics hardware 106 do more work.

When the rendering system determines there is an imbalance or bottleneck due to the graphics hardware 106, the software zone size is accordingly decreased (block 142). This increases the software driver workload and correspondingly decreases the graphics hardware workload. The decrease in the graphics hardware workload is attributed to increased efficiency of the cache. Thus, if the graphics hardware 106 is causing the bottleneck, the software zone size is decreased. In another embodiment, graphics hardware may be depicted as an extra block that is queried as to whether there is a bottleneck prior to block 142. If so, the zone size is decreased accordingly (step 142). If not, an error condition is communicated and the zone size is not adjusted. The embodiment returns to monitored another set number of predetermined frames as noted in flow diagram 130. One skilled in the art will recognize that it is not critical what sequence the software and/or hardware are monitored. In some applications, both software and hardware are monitored concurrently.

The zone size can be adjusted to range anywhere between the cache size (minimum) and the screen size (maximum). When the zone size is set to its maximum (i.e. the screen size), the number of zones 124 is effectively equal to one and the rendering system becomes similar or equivalent to traditional rendering systems that are not concerned with optimizing the graphics hardware cache.

If there is no detected imbalance or the imbalance is negligible, the software zone size is not adjusted and the system is monitored after another predetermined number of cycles to determine if the software zone needs to be adjusted. The process can be continued for as long as balancing between the software driver and graphics hardware is desired.

In a typical implementation, the render cache is employed to cache intermediate color and depth buffer values. The render cache is logically organized as a 2-dimensional cache and of a fixed total size. The cache supported may be a 16 KB render cache, split into 8 KB for color values and 8 KB for depth values. A possible cache dimension (in pixels) supported by this implementation for a 32 BPP mode is 64 pixels wide by 32 pixels high. Correspondingly, for zone rendering, the minimum zone size would be approximately equal to the hardware cache size of 64 pixels wide by 32 pixels high. The maximum zone size would be approximately equal to a screen size of 1024 by 768 pixels.

In a typical embodiment, the zone 124 is initially set to a predetermined size depending on the application. In some embodiments, the predetermined size is equal or approximately equal to the hardware cache size although one skilled in the art will recognize that the zone size can be set to other suitable sizes as well. A few frames are then run to gather performance data. As noted above, one or more factors can be used to determine whether the software zone size should be changed to compensate for an imbalance in workload between the driver and the hardware 106. For example, the total driver time required to render a given scene is compared to the overall CPU time to determine a driver CPU utilization ratio. If the system is not balanced according to the performance data gathered, the zone size is adjusted accordingly. A few more frames are then run, performance data gathered, software zone adjusted accordingly and so forth. One skilled in the art will recognize that the present invention thus provides a dynamic approach to software zone rendering and is particularly applicable to integrated graphics hardware devices that require software zone rendering. One skilled in the art will recognize that the present invention is applicable to other configurations as well.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A method for balancing workloads of graphics related software and hardware associated with a zone renderer rendering at least one object comprising:
configuring the zone renderer to a predetermined size;
monitoring hardware or software for a predetermined time period;
determining whether there is an imbalance between the hardware and software; and
adjusting the size of the zone renderer to minimize the imbalance.

2. The method of claim 1 wherein configuring the zone renderer to a predetermined size comprises:
configuring the zone renderer to approximate a size of a cache associated with the hardware.

3. The method of claim 1 wherein monitoring hardware or software for predetermined period comprises:
polling the hardware for a predetermined number of cycles.

4. The method of claim 1 wherein monitoring hardware or software for predetermined period comprises:
determining an execution time for software associated with rendering at least one object in relation to total processing time.

5. The method of claim 3 wherein monitoring hardware or software for predetermined period comprises:
determining an execution time for software associated with rendering at least one object in relation to total processing time.

6. The method of claim 1 wherein adjusting the size of the zone renderer to minimize the imbalance comprises:
increasing the size of the zone renderer when there is an imbalance associated with the software.

7. The method of claim 1 wherein adjusting the size of the zone renderer to minimize the imbalance comprises:
decreasing the size of the zone renderer when there is an imbalance associated with the hardware.

8. The method of claim I wherein the maximum zone size is equal or approximately equal to a display which receives rendered objects.

9. The method of claim 1 wherein the minimum zone size is equal or approximately equal to the size of a cache associated with the hardware.

10. A machine readable medium having stored therein a plurality of machine readable instructions executable by a processor, the machine readable instructions comprising:
instructions to configure a graphics zone renderer to a predetermined size, monitor hardware or software for a predetermined time period, determine whether there is an imbalance between the hardware and software and adjust the size of the zone renderer to minimize the imbalance.

11. The machine readable medium of claim 10 wherein the machine readable instructions to configure the zone renderer to a predetermined size further comprise instructions to configure the zone renderer to approximate a size of a cache associated with the hardware.

12. The machine readable medium of claim 10 wherein the machine readable instructions to monitor the hardware or software for predetermined period further comprises instructions to poll the hardware for a predetermined number of cycles.

13. The machine readable medium of claim 10 wherein the machine readable instructions to monitor hardware or software for predetermined period further comprises instructions to determine an execution time for software associated with rendering at least one object in relation to total processing time.

14. The machine readable medium of claim 12 wherein the machine readable instructions to monitor hardware or software for predetermined period further comprises instructions to determine an execution time for software associated with rendering at least one object in relation to total processing time.

15. The machine readable medium of claim 10 wherein the machine readable instructions to adjust the size of the zone renderer to minimize the imbalance further comprises instructions to increase the size of the zone renderer when there is an imbalance associated with the software.

16. The machine readable medium of claim 10 the machine readable instructions to adjust the size of the zone renderer to minimize the imbalance further comprises instructions to decrease the size of the zone renderer when there is an imbalance associated with the hardware.

17. The machine readable medium of claim 10 wherein the maximum zone size is equal or approximately equal to a display which receives rendered objects.

18. The machine readable medium of claim 10 wherein the minimum zone size is equal or approximately equal to the size of a cache associated with the hardware.
